(19) United States
(12) Patent Application Publication
(10) Pub. No.: US 2022/0074146 A1
(43) Pub. Date: Mar. 10, 2022

(54) Paving Block with Improved Illumination

(71) Applicant: Glow Path Pavers, LLC, West Bloomfield, MI (US)

(72) Inventors: Alex Ketty, West Bloomfield, MI (US); John Ketty, Birmingham, MI (US)

(73) Assignee: Glow Path Pavers, LLC, West Bloomfield, MI (US)

(21) Appl. No.: 17/529,715

(22) Filed: Nov. 18, 2021

Related U.S. Application Data
(63) Continuation-in-part of application No. 17/404,534, filed on Aug. 17, 2021.
Application No. 17/404,534 is a continuation of application No. PCT/US2020/018755, filed on Feb. 19, 2020.

(51) Int. Cl. E01C 17/00; E01C 5/06

(52) U.S. Cl. CPC E01C 17/00; C04B 2111/807; E01C 5/065

(57) ABSTRACT

A method of manufacturing a paving block with embedded photoluminescent material, comprising the steps of mixing sand, aggregate, water, and cement to form an uncured concrete mixture; mixing phosphorescent pigments, sand, cement, aggregate, and water to form an uncured phosphorescent mixture; providing a paving block mold; pouring the uncured concrete mixture into the paving block mold to fill the paving block mold; compressing the uncured concrete mixture in the paving block mold via a tamper head until the paving block mold is between 80% and 90% full; pouring the uncured phosphorescent mixture into the paving mold block to substantially fill the paving block mold; and compressing and vibrating the uncured concrete mixture and the uncured phosphorescent mixture in the paving mold block to generate an uncured paving block having a desired thickness and density.

### CROSS-REFERENCES TO RELATED APPLICATIONS

This application is a continuation in part of U.S. application Ser. No. 17/404,534 filed on Aug. 17, 2021, which is a continuation of International Application Serial Number PCT/US2020/018755 filed Feb. 19, 2020, which claims priority from U.S. application Ser. No. 16/373,082 filed Apr. 2, 2019, all of which are each hereby incorporated herein by reference in their respective entirety.

### FIELD OF INVENTION

The present invention relates generally to outdoor surface construction and more specifically to a paving block with improved illumination, which provides illumination without the need for electrical power.

### DISCUSSION OF THE PRIOR ART

Paving blocks are used for walkways, large public pedestrian areas, driveways, paths and the like. The paving blocks allow ground action without deterioration. Paving blocks, like cement blocks for pathways, can be laid in various patterns that are aesthetically pleasing. Walkway lighting for pathways have been used along with paving blocks to increase safety, provide sure footing and visibility. Many walkways are illuminated with low or medium voltage lighting, and must be furnished with low- or medium voltage electricity to power an illumination system. There are electrical consumption costs associated with the use of illumination systems. There are also difficulties in setup of the illumination system, if the walkway is a long walkway or is located at a distance from an electrical connection. A licensed contractor must be hired to install electrical supplies for the illumination system.

The use of outdoor lighting is known in the prior art. For example, U.S. Pat. No. 6,027,280 to Connors et. al (Connors) discloses an interlocking paving block with interior illumination capability. However Conners does not allow for non-electrical use of an outdoor light. Similarly, U.S. Pat. No. 5,472,737 to Anders (Anders 737) discloses a photoluminescent highway paint composition that is painted on highways to aid in driving.

However, Anders 737 does not disclose the use of paving blocks. Lastly, U.S. Pat. No. 6,005,024 to Anders et al (Anders 024) discloses a photoluminescent overlay that covers existing signs and gives moisture stability to the phosphorescent materials.

However, Anders 024 does not disclose the use of paving blocks.

While the above-described devices fulfill their respective objections and requirements, the aforementioned patents do not describe a photoluminescent paving block that allows for being used for outdoor lighting. Connors makes no provision for non electrical use, since it includes an insect bulb and wiring.

Anders 737 and 024 only disclose the use of photoluminescent material in conjunction with paving blocks.

Additionally, U.S. Pat. No. 6,665,986 to Kaplan discloses a phosphorescent paving block. US Patent Publication no. 2006/0065879 to Beimel discloses a luminous cementitious composition and methods of making and using the same. U.S. Pat. No. 8,617,638 to Hill discloses a method of manufacturing photoluminescent pavers at a paver manufacturing facility. However, U.S. Pat. No. 9,114,422 to Toma et al. discloses a paving block with embedded photoluminescent material. U.S. Pat. No. 9,114,422 is hereby incorporated by reference in its entirety. Accordingly, there is a clearly felt need in the art for a paving block with improved illumination, which provides illumination without the need for electrical power.

### SUMMARY OF THE INVENTION

The present invention provides a paving block with improved illumination, which provides illumination without the need for electrical power. The paving block with improved illumination (luminescent paving block) preferably includes a concrete base layer and a photoluminescent layer. The photoluminescent layer is formed on top of the concrete base layer. The concrete base layer is created by combining sand, aggregate, water, pigment and cement to form an uncured concrete mixture. The photoluminescent layer preferably includes very fine aggregate, cement, water, pigment, sand and a photoluminescent pigment.

Accordingly, it is an object of the present invention to provide a luminescent paving block, which has all of the advantages of the prior art for outdoor lighting and none of the disadvantages.

It is further object of the present invention to provide a luminescent paving block, which may be easily and efficiently manufactured and marketed. It is yet a further object of the present invention to provide a luminescent paving block, which has a low cost of manufacture with regard to both materials and labor.

It is yet a further object of the present invention to provide a luminescent paving block, which requires no wiring, no electrical power consumption and no installation by an electrical contractor.

Finally, it is another object of the present invention to provide a luminescent paving for outdoor lighting that is aesthetically pleasing.

These and additional objects, advantages, features and benefits of the present invention will become apparent from the following specification.

Therefore, an aspect of some embodiments of the present invention relate to a method of manufacturing a paving block with embedded photoluminescent material, comprising the steps of: mixing sand, aggregate, water, and cement to form an uncured concrete mixture; mixing phosphorescent pigments, sand, cement, aggregate, and water to form an uncured phosphorescent mixture; providing a paving block mold; pouring the uncured concrete mixture into the paving block mold to fill the paving block mold; compressing the uncured concrete mixture in the paving block mold via a tamper head until the paving block mold is between 80% and 90% full; pouring the uncured phosphorescent mixture into the paving mold block to substantially fill the paving block mold; and compressing and vibrating the uncured concrete mixture and the uncured phosphorescent mixture in the paving mold block to generate an uncured paving block having a desired thickness and density.

In a variant, the method further includes allowing the uncured paving block to cure via contact with air for a set period of time in a controlled environment, to form a cured paving block.

In some embodiments of the present invention, the method further includes, during the set period of time, removing a portion of a top surface of the uncured paving block to expose the photoluminescent pigments.

The removing may include at least one of: sand blasting the top surface of the uncured paving block; pressure washing the top surface of the uncured paving block with water; machine brushing the top surface of the uncured paving block.

In some embodiments of the present invention, the method further includes, after the set period of time, removing a portion of a top surface of the uncured paving block to expose the photoluminescent pigments.

The removing may include at least one of: polishing the top surface of cured paving block with a polishing paste and removing the polishing paste; grinding the top surface of cured paving block; burnishing the top surface of cured paving block.

In a variant, the method further includes applying a transmissive sealant to cover the photoluminescent layer.

In a variant, the photoluminescent pigments comprise phosphorescent pigments.

### BRIEF DESCRIPTION OF DRAWINGS

FIG. 1 is a perspective view of a luminescent paving block reflecting light, according to some embodiments of the present invention;

FIG. 2 is a perspective view of an apparatus for manufacturing a photoluminescent paving block, according to some embodiments of the present invention;

FIG. 3 shows a uncured cement mixture being poured into a mold for manufacturing a photoluminescent paving block, according to some embodiments of the present invention;

FIG. 4 shows the mold substantially full of uncured concrete mixture, according to some embodiments of the present invention;

FIG. 5 shows the uncured concrete mixture being compressed inside the mold, according to some embodiments of the present invention;

FIG. 6 shows the uncured concrete mixture in the mold after having been compressed, according to some embodiments of the present invention;

FIG. 7 shows an uncured photoluminescent mixture being poured on top of the uncured cement mixture in the mold, according to some embodiments of the present invention;

FIG. 8 shows the mold being substantially filled by the uncured photoluminescent mixture, according to some embodiments of the present invention;

FIG. 9 shows the uncured cement mixture and the uncured photoluminescent mixture being compressed and vibrated inside the mold, according to some embodiments of the present invention;

FIG. 10 shows the uncured photoluminescent mixture in the mold after the compression and vibration of the uncured cement mixture and the uncured photoluminescent mixture, according to some embodiments of the present invention; and

FIG. 11 shows a paving block having a photoluminescent layer above a base layer, according to some embodiments of the present invention.

### DETAILED DESCRIPTION OF THE EMBODIMENTS OF THE INVENTION

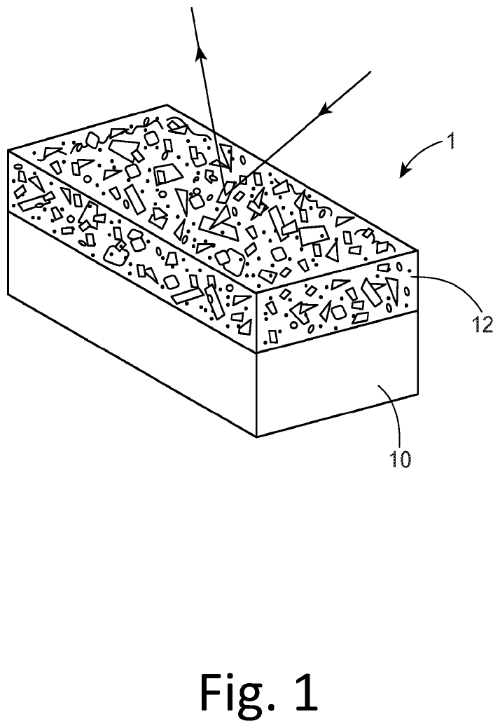

With reference now to the drawing, and particularly to FIG. 1, there is shown a perspective view of a luminescent paving block 1. The luminescent paving block 1 includes a concrete base layer 10 and a photoluminescent layer 12. The photoluminescent layer 12 is formed on top of the concrete base layer 10. The concrete base layer 10 is preferably created by combining sand, aggregate, water pigment and cement to form an uncured concrete mixture. The photoluminescent layer 12 preferably includes very fine aggregate, cement, water, pigment, sand and a polyester resin infused with a photoluminescent pigment or a silica-based glass material infused with photoluminescent pigment. Further, a light transmitting sealant may be placed over the photoluminescent layer 12. In some embodiments of the present invention, the sand in the photoluminescent layer 12 includes at least some photoluminescent sand.

The photoluminescent pigment preferably includes strontium aluminate doped with europium. The polyester resin is mixed with the strontium aluminate pigment to form a polyester resin mixture. The polyester resin is mixed with the strontium aluminate pigment to form an evenly distributed suspension, and is poured into shallow forms to cure and harden. When the polyester resin mixture is fully cured, the hardened polyester resin mixture is crushed in a hammer-mill or with any other suitable device to create a mixture of randomly sized chips or particles to form polyester resin mixture fragments.

The silica-based glass material is mixed with the strontium aluminate pigment to form a silica-based glass mixture. The silica-based glass is mixed with the strontium aluminate pigment to form an evenly distributed suspension, and is poured into shallow forms in preparation of firing in a glass kiln. After the silica-based glass mixture is fully fired, the glass is allowed to cure and harden. The fully cooled and cured silica-based glass mixture is then crushed with a hammer-mill or with any other suitable device to create a mixture of randomly sized chips or particles to form silica-based glass fragments.

The following dimensions are given by way of example and not by way of limitation. When the luminescent paving block has a thickness of about 2⅜ inches. The concrete base layer 10 preferably has a thickness of between 1⅞ to 2⅛ inches. The photoluminescent layer 12 preferably has a thickness of no greater than 0.5 inches. The concrete base layer 10 is created by combining the sand, the aggregate, water, pigment and the cement to form an uncured concrete mixture. The uncured concrete mixture is poured into a paving block mold (not shown) to the preferred height. The concrete base layer 10 is then compressed with a hydraulic press to further drive out any gaps or voids, and to enhance durability of the concrete base layer 10 to enhance its ability to withstand rated loads and environmental forces. The photoluminescent layer 12 is created by combining the very fine aggregate, the sand (which may include photoluminescent sand), the cement, water, pigment, and a polyester resin infused with a photoluminescent pigment or a silica-based glass material infused with photoluminescent pigment to form an uncured photoluminescent mixture. The uncured photoluminescent mixture is poured over the uncured concrete mixture. The photoluminescent layer 12 is then compressed with a hydraulic press to further drive out any gaps or voids, and to enhance durability of the photoluminescent layer 12 to enhance its ability to withstand rated loads and environmental forces. The paving block mold is then vibrated on a shaker table. The shaker table is a device well known in the art, which is designed to agitate the uncured concrete mixture to drive out any gaps, voids or air spaces. Additionally, the cast concrete block 10 is allowed to cure for up to 28 days in a controlled environment. Finally, when fully dry and cured, the paving block 1 is subjected to a light surface grinding, which removes excess concrete material from a top surface and the sand and the polyester resin mixture fragments or the silica-based glass fragments on the surface of the luminescent paving block 1. A light transmissive sealant including a methyl methacrylate or polyurethane material may be applied in the form of spray, after the paving block 1 is ground. The light transmissive sealant is allowed to dry for 24 hours, before the luminescent paving block 1 is ready to be inventoried and shipped.

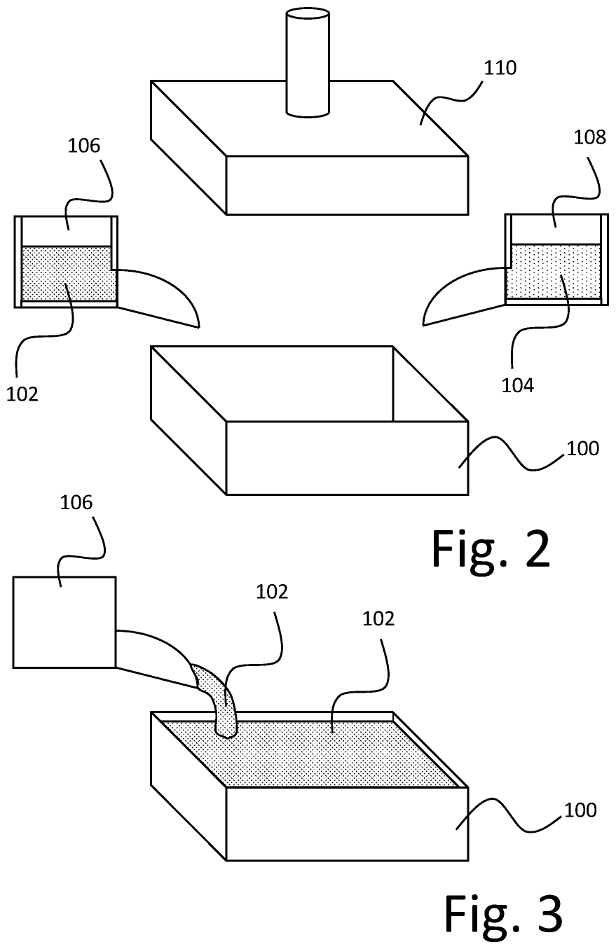

Referring now to FIGS. 2-11, another embodiment of the present invention is described, relating to a technique for manufacturing a paving block having a photoluminescent layer in which photoluminescent pigments are mixed directly with water, cement, and aggregate, without being infused with resin or glass material.

An uncured concrete mixture 102 is formed by mixing at least sand, aggregate, water, and cement. In some embodiments of the present invention, one or more of slag, fly ash, high-range water-reducing admixture (HRWRA), and silica fume are also part of the uncured mixture. In some embodiments of the present invention, the cement includes Type 1 Ordinary Portland Cement (OPC). However, any other type of cement or mix of different cement types may be used, as chosen by a person skilled in the art. In some of the present invention, the aggregate includes Stone 57 and Stone 89. However, other sizes of aggregates may be used, as chosen by a person skilled in the art.

Non-limiting examples of the uncured concrete mixture are shown in Table 1 below. All the values in the table may vary in the range of ±15%. It should be noted that these examples are only examples and a person skilled in the art may use different materials and different quantities thereof. The scope of the present invention extends to any type of cement mix which includes at least sand, aggregate, water, and cement.

TABLE 1

| | Formula (Quantity, lb/yd³) of uncured concrete mixture | | | | | | |
|---|---|---|---|---|---|---|---|
| Component | Mix 1 | Mix 2 | Mix 2 | Mix 3 | Mix 4 | Mix 5 | Mix 6 |
| Type 1 OPC | 552.5 | 276.25 | 442 | 510 | 442 | 552.5 | 552.5 |
| Slag | — | 255 | — | — | 110.5 | — | — |
| Fly ash | — | — | 110.5 | — | — | — | — |
| Silica Fume | — | — | — | 42.50 | — | — | — |
| Stone 57 | 811.75 | 811.75 | 811.75 | 811.75 | 811.75 | 811.75 | 811.75 |
| Stone 89 | 811.75 | 811.75 | 811.75 | 811.75 | 811.75 | 811.75 | 811.75 |
| HRWRA | 5.95 | 5.95 | 5.95 | 5.95 | 5.95 | 5.95 | 5.95 |
| Sand | 755.65 | 755.65 | 755.65 | 755.65 | 755.65 | 755.65 | 755.65 |
| Water | 221 | 221 | 221 | 221 | 221 | 249 | 276.25 |
| Water/Cement Ratio | 0.40 | 0.40 | 0.40 | 0.40 | 0.40 | 0.45 | 0.50 |

A photoluminescent mixture 104 is formed by mixing at least photoluminescent pigments, sand, cement, aggregate, and water. The photoluminescent mix may also include HRWRA. The photoluminescent pigments are mixed directly with pigments, sand, cement, aggregate and water, without being infused with glass material or polystyrene resin. Polystyrene resin may fade out over the time due to UV exposure and may be release harmful chemicals Glass may fade out over the time. In this novel formulation, the photoluminescence of the paving block is retained for a longer time.

The aggregate may include Stone 89, but other aggregate sizes may be used as deemed by a person skilled in the art. The scope of the present invention extends to the use of any type of cement, stone, or photoluminescent material.

An example of the composition of the photoluminescent mix is shown below, in Table 2. It should be noted that these examples are only examples and a person skilled in the art may use different materials and different quantities thereof. The scope of the present invention extends to any type of cement mix which includes at least sand, aggregate, water, and cement. All the values in the table may vary in the range of 15%.

In some embodiments of the present invention, the photoluminescent pigments include phosphorescent materials. Non-limiting examples of suitable pigments include Europium doped Strontium Aluminate, or Europium doped ZnO or Dy₂O₃ doped Strontium Aluminate.

TABLE 2

| | Formula (Quantity, lb/yd³) to make face mix of the surface of the brick | | | | | | |
|---|---|---|---|---|---|---|---|
| Component | Mix 1 | Mix 2 | Mix 2 | Mix 3 | Mix 4 | Mix 5 | Mix 6 |
| Type 1 OPC | 97.5 | 97.5 | 97.5 | 97.5 | 97.5 | 97.5 | 97.5 |
| Stone 89 | 258.75 | 264.3 | 270 | 275 | 281 | 284 | 287 |
| Glow materials | 27.75 | 22.20 | 16.80 | 11.25 | 5.55 | 2.70 | 1.50 |
| HRWRA | 1.05 | 1.05 | 1.05 | 1.05 | 1.05 | 1.05 | 1.05 |
| Sand | 133.35 | 133.35 | 133.35 | 133.35 | 133.35 | 133.35 | 133.35 |
| Water | 39 | 39 | 39 | 39 | 39 | 43.88 | 48.75 |
| Water/Cement | 0.40 | 0.40 | 0.40 | 0.40 | 0.40 | 0.45 | 0.50 |

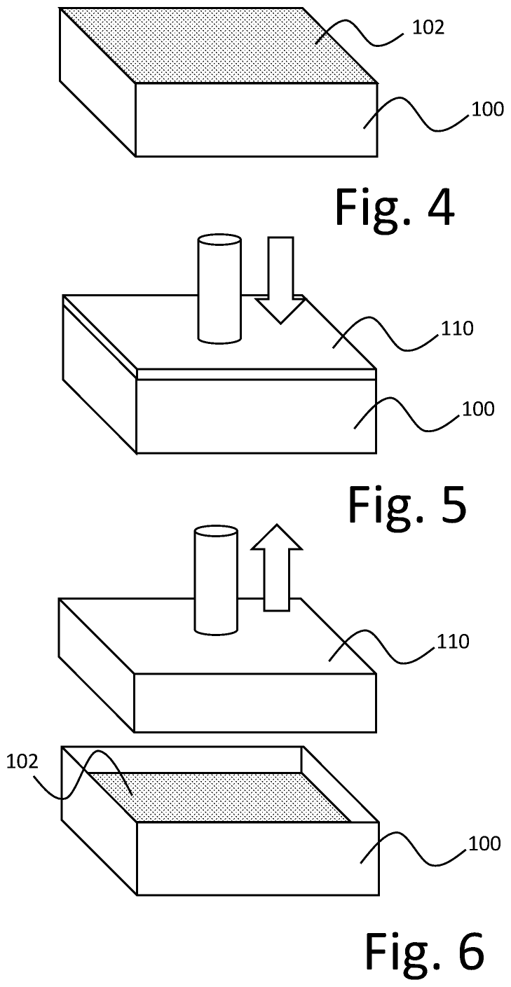

A paving block mold 100 is provided. The uncured concrete mixture 102 is poured into the mold 100, for example via a first feeder box 106, as seen in FIG. 3, until the mold 100 is substantially filled (full between 95% and 100%), as shown in FIG. 4.

The uncured concrete mixture 102 is compressed within the mold 100 until the mold 100 is about 85% full (between 80% and 90% full), as seen in FIGS. 5 and 6. The compressing may be performed, for example, via a tamper head 110.

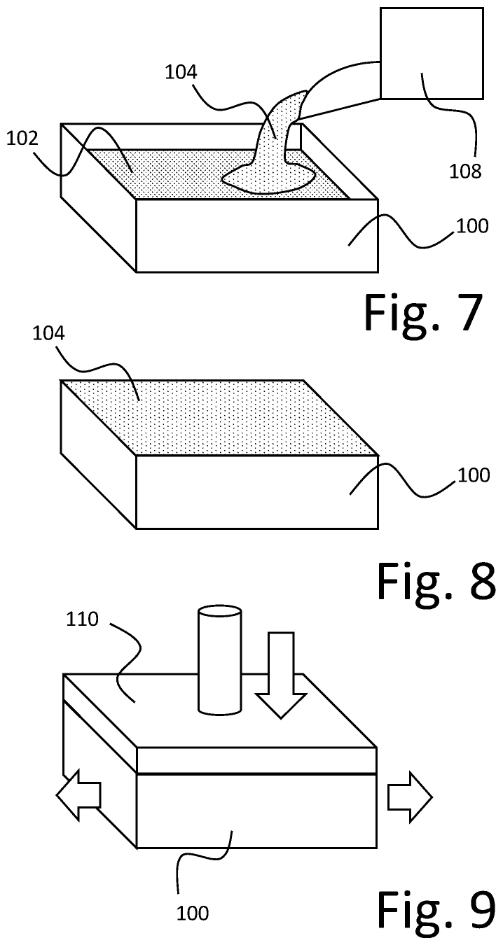

The photoluminescent mixture 104 is poured in the mold 100 on top of the concrete mixture 102 to substantially fill the mold 100, so the mold 100 is between 95% and 100% full, as shown in FIGS. 7 and 8.

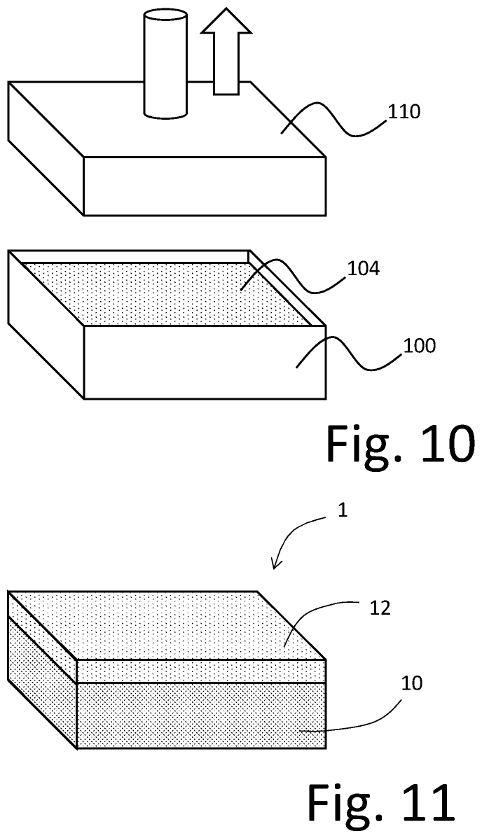

In FIG. 9, the concrete mixture and the photoluminescent mixture are compressed (for example via tamper head 110) and vibrated to form an uncured paving block having a desired thickness and density. The density and thickness are determined by a person skilled in the art. The compression and vibrations end in FIG. 10, when the tamper head 110 is removed from the mold 100. The resulting uncured paving block 1, has a base layer formed 10 by the cement mixture and a photoluminescent layer 12 above the base layer 10. The photoluminescent layer 12 is formed by the photoluminescent mixture. In some embodiments of the present invention, the base layer 10 forms about 85% (for example, between 75% and 90%) of the paving block 1, while the photoluminescent layer 12 forms about 15% (for example, between of 10% and 25%) of the paving block 1.

The uncured paving block is removed from the mold and allowed to cure via contact with air for a set period of time in a controlled environment, to form a cured paving block. The set period of time may vary according to the temperature and humidity of the controlled environment. In an environment having a temperature between 15° C. and 40° C. degrees Celsius and relative humidity between 50% and 60%, the curing period is between 8 and 12 hours, for example, about 10 hours.

In some embodiments of the present invention, a portion of the top surface of the paving block 1 is removed during curing, in order to expose the photoluminescent pigments in the photoluminescent layer. This may be accomplished via one or more different techniques, such as sand blasting the top surface of the uncured paving block, pressure washing the top surface of the uncured paving block with water, or machine brushing the top surface of the uncured paving block, for example.

Alternatively or additionally to the removal of the portion during curing, a portion of a top surface of the paving block may be removed to expose the photoluminescent pigments, after the paving block is cured, that is after the set period of time. The techniques may include one or more of polishing the top surface of cured paving block with a polishing paste and removing the polishing paste, grinding the top surface of cured paving block (for example with a fine grit diamond blade), and burnishing the top surface of cured paving block, for example. The polishing paste may include a diamond paste and/or a Al₂O₃ paste, for example. The polishing is made by machine, such as a Vevor Concrete Floor Grinder 10″ Walk-behind Polisher 1.5 hp Adjustable Machine, for example.

In some embodiments of the present invention, a transmissive sealant is applied to the top of the block 1 to cover the photoluminescent layer 12, as described above.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A method of manufacturing a paving block with embedded photoluminescent material, comprising the steps of:
mixing sand, aggregate, water, and cement to form an uncured concrete mixture;
mixing photoluminescent pigments, sand, cement, aggregate, and water to form an uncured photoluminescent mixture;
providing a paving block mold;
pouring the uncured concrete mixture into the paving block mold to substantially fill the paving block mold;
compressing the uncured concrete mixture in the paving block mold via a tamper head until the paving block mold is between 80% and 90% full;
pouring the uncured photoluminescent mixture into the paving mold block to substantially fill the paving block mold; and
compressing and vibrating the uncured concrete mixture and the uncured photoluminescent mixture in the paving mold block to generate an uncured paving block having a desired thickness and density, the uncured paving block having a base layer and a photoluminescent layer above the base layer.

2. The method claim 1, further comprising:
allowing the uncured paving block to cure via contact with air for a set period of time in a controlled environment, to form a cured paving block.

3. The method claim 2, further comprising, during the set period of time:
removing a portion of a top surface of the uncured paving block to expose the photoluminescent pigments.

4. The method of claim 3, wherein the removing comprises at least one of:
sand blasting the top surface of the uncured paving block;
pressure washing the top surface of the uncured paving block with water;
machine brushing the top surface of the uncured paving block.

5. The method of claim 2, further comprising, after the set period of time:
removing a portion of a top surface of the cured paving block to expose the photoluminescent pigments.

6. The method of claim 3, wherein the removing comprises at least one of:
polishing the top surface of cured paving block with a polishing paste and removing the polishing paste;
grinding the top surface of cured paving block;
burnishing the top surface of cured paving bock.

7. The method of claim 2, further comprising:
applying a transmissive sealant to cover the photoluminescent layer.

8. The method of claim 1, wherein the photoluminescent pigments comprise phosphorescent pigments.
